(19) United States
(12) Patent Application Publication
(10) Pub. No.: US 2010/0251850 A1
(43) Pub. Date: Oct. 7, 2010

(54) Crank Transmission Mechanism with Elliptical Trace

(76) Inventor: Cheng Bin WANG, Taichung City (TW)

Correspondence Address: Wang Law Firm, Inc., 4989 Peachtree Parkway,, Suite 200, Norcross, GA, 30092, US

(21) Appl. No.: 12/164,697

(22) Filed: Jun. 30, 2008

(51) Int. Cl. B62M 3/02

(52) U.S. Cl. 74/594.3

(57) ABSTRACT

A crank transmission mechanism includes a crank unit having a rail portion connected to an end thereof and a guide member is connected with a shaft which is connected with a disk. The rail portion is movably engaged with the guide member. A transmission unit is connected between the crank unit and the disk, the rail portion and the guide member are connected to the transmission unit. The transmission unit is adjusted according to the relative position between the rail portion of the crank unit and the guide member. The crank transmission mechanism is compact and the torque can be adjusted by slowly adjusting the length of the crank unit. The crank transmission mechanism can be used to bicycles, tricycles and elliptical exercising machine.

### FIELD OF THE INVENTION

The present invention relates to a crank transmission mechanism and the cranks moves along an elliptical trace.

### BACKGROUND OF THE INVENTION

A conventional crank transmission mechanism is widely used in bicycles and sport facilities and saves effort. Users drive the cranks of the conventional crank transmission mechanism along a circular trance so as to rotate a sprocket which is connected with a chain or belt to deliver and drives another part. However, the cranks have a fixed length so that the user has to adjust his or her ankles to rotate the cranks. This makes the user to feel tired and sometimes get hurt because the circular trace of the cranks is not matched with the elliptical trace of the user's joints.

As shown in FIG. 4, an improved crank transmission mechanism 9 is developed and includes a pedal 91, an oval board 92, a sleeve 93, a crank 94 and a guide pin 95. The oval board 92 is connected to a bicycle frame (not shown) and an oval groove 921 is defined in the oval board 92. The sleeve 93 is connected with the sprocket 96 of the bicycle so as to drive a chain (not shown). A passage 931 is defined in the sleeve 93 and one end of the rod 94 is connected to the pedal 91 and the other end of the crank 94 is movably inserted into the passage 931. The guide pin 95 extends trough the crank 94 and movably engaged with the oval groove 921.

The improved crank transmission mechanism 9 allows the length of the crank 94 variable when operating the mechanism 9 and the torque transferred to the sprocket 96 varies with the change of the length of the crank 94. The trace of the crank 94 is not a circle so that it improves the shortcomings of the circular trace of the conventional crank mechanism. However, the mechanism 9 occupies a large space and can be easily damaged. Besides, once a foreign object such as a small rock enters the oval groove 921, the mechanism 9 cannot operate normally.

The present invention intends to provide a crank transmission mechanism with an elliptical trace, and the mechanism is compact and has a tight connection relationship between parts. The cranks move along an elliptical trace so as to improve shortcomings of the conventional crank transmission mechanism.

### SUMMARY OF THE INVENTION

The present invention relates to a crank transmission mechanism which comprises a crank unit and a rail portion is connected to the crank unit. A guide member is engaged with the rail portion so that the rail portion is movably engaged with the guide member. The rail portion and the guide member are cooperated with a disk. A transmission unit is connected between the crank unit and the disk, the rail portion and the guide member are connected to the transmission unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the crank transmission mechanism of the present invention;

FIG. 2 is an exploded view to show the crank transmission mechanism of the present invention;

FIG. 3 shows the parts of the crank transmission mechanism of the present invention, and

FIG. 4 shows a conventional crank transmission mechanism.

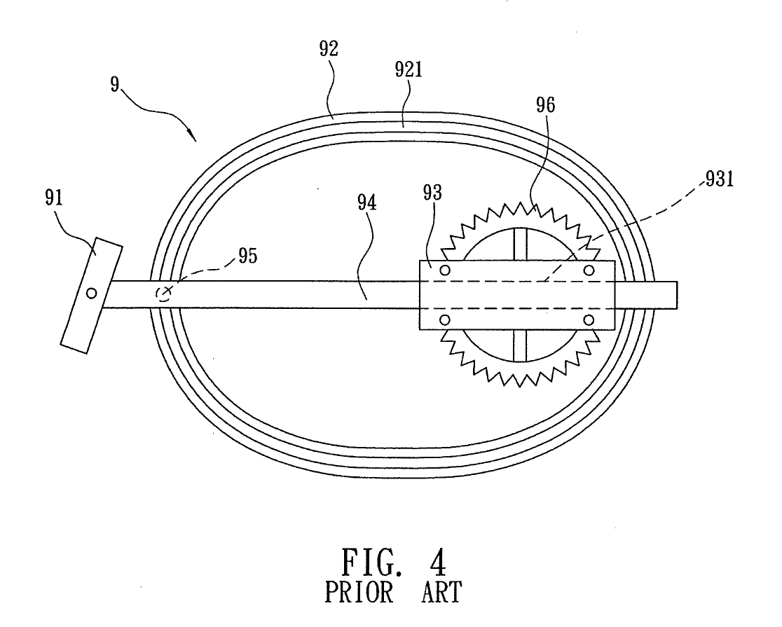

### DETAILED DESCRIPTION OF THE PREFERRED EMBODIMENT

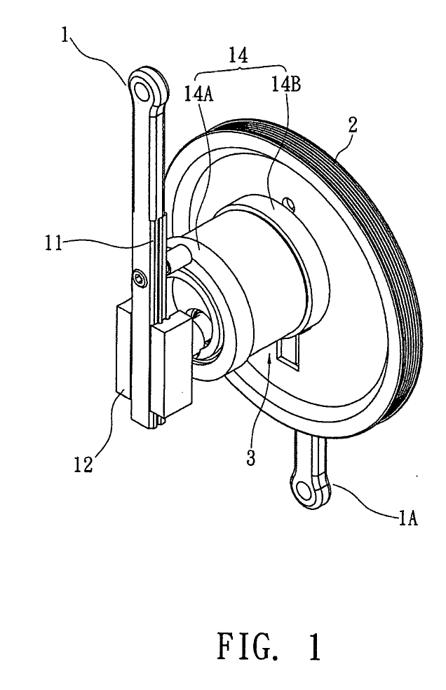

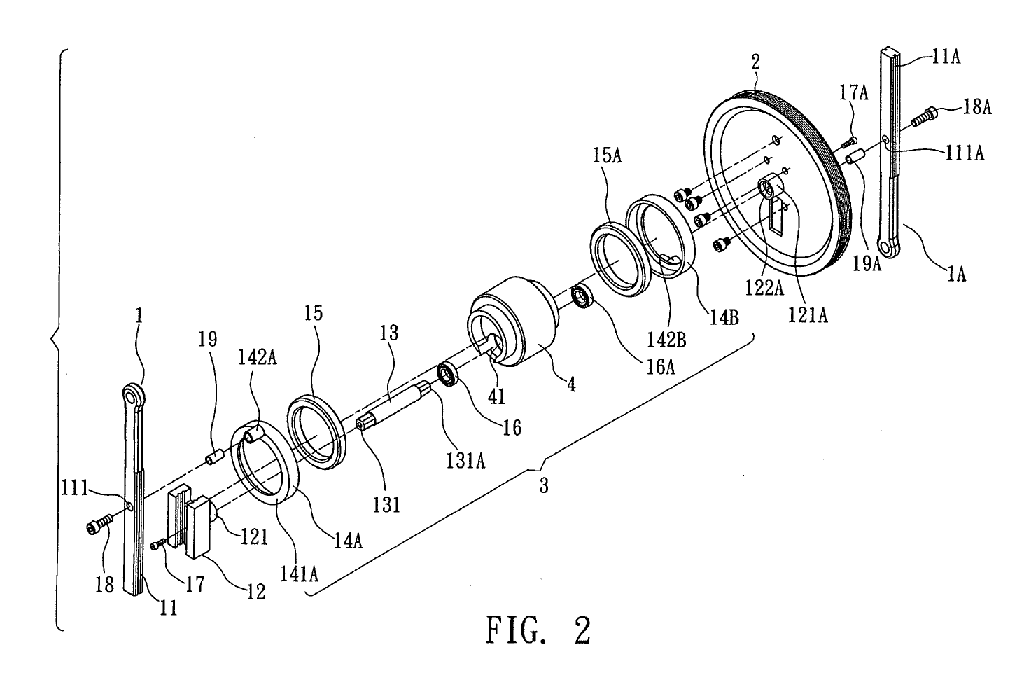

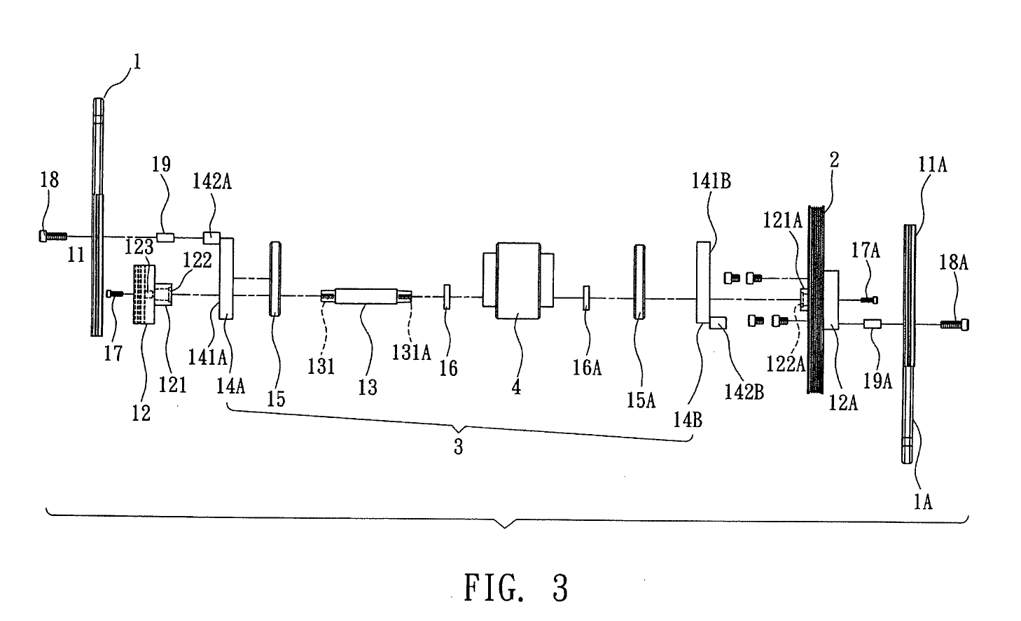

Referring to FIGS. 1 to 3, the crank transmission mechanism of the present invention comprises a crank unit including at least one crank, in this embodiment, there are two cranks 1, 1A. The two cranks 1, 1A each have a rail portion 11/11A at one end thereof and the two respective rail portions 11/11A are movable engaged with two respective guide members 12/12A. A disk 2 can be a sprocket and connected with a chain or belt (not shown). A transmission unit 3 is connected between the two cranks 1, 1A and the disk 2. The rail portions 11, 11A and the guide members 12, 12A are connected to the transmission unit 3.

The transmission unit 3 includes a shaft 13 and a collar unit 4, the shaft 13 connected to a central axis of the disk 2 and the collar unit 4 is mounted to the shaft 13. The collar unit 4 includes two collar members 14A, 14B, wherein the collar member 14B is connected to the disk 2 and the crank 1A, the collar member 14A is connected with the crank 1. A frame 4 is mounted to the shaft 13 and the two collar members 14A, 14B are mounted to two ends of the frame 4. Two first bearings 15, 15A are located between the tow collar members 14A, 14B and the two ends of the frame 4. A common axis of the two collar members 14A, 14B is parallel to central axis of the disk 2. In this embodiment, the frame 4 is a bottom bracket.

The two collar members 14A, 14B each have an annular flange 141A/141B extending inward from a side thereof and the diameter enclosed by the flange 141A/141B is smaller than the diameter of the other side of the collar member 14A/14B. The side having the flange 141A/141B is located away from the frame 4. Two respective connection members 142A, 142B extend perpendicularly from the two flanges 141A, 141B. Each of the two cranks 1, 1A has a hole 111/111A defined through and two respective bolts 18, 18A extend through the two holes 111, 111A and are connected with the connection members 142A, 142B. The frame 4 includes a path 41 defined axially therethrough and the shaft 13 extends through the path 41 and a center of the disk 2. Two second bearings 16, 16A are mounted to two ends of the shaft 13 and two ends of the shaft 13 extend out from two ends of the frame 4.

The two guide members 12, 2A each have a passage 122/122A defined therein and the two ends of the shaft 13 are connected with the passages 122, 122A. The two guide members 12 each include a protrusion 121/121A extending therefrom and the passages 122, 122A are defined in the two protrusions 121, 121A. Two threaded holes 131, 131A are defined in the two ends of the shaft 13 and two through holes 123 are defined in the two guide members 12, 12A respectively. Two bolts 17, 17A extend through the two through holes 123 and enter the passages 122, 122A so as to be connected with the threaded holes 131, 131A of the shaft 13.

The two cranks 1, 1A are located parallel to the disk 2 and the rail portions 11, 11A of the two cranks 1, 1A are located close to a center of the disk 2, the two cranks 1, 1A extend in two opposite directions. The two connection members 142A, 142B are located on a common plane which passes through two respective centers of the two collar members 14A. 14B, the two connection members 142A, 142b are located on two opposite directions.

When using the mechanism, the crank 1 is located at the upright position and the distance between the connection member 142A and the axis of the disk 2 is the smallest. The length that the rail portion 11 inserts into the guide member 12 is the maximum value. When the crank 1 rotates, the rail portion 11 slides along the guide member 12 so that the arm of force formed by the crank 1 to the disk 2 increases gradually. When the crank 1 is pivoted to 90-degree position, the arm of force has the maximum value. When the crank 1 is pivoted to 180-degree position, the distance between the connection member 142A to the axis of the disk 2 has the maximum value and the length that the crank 1 extends beyond the guide member 12 has the maximum value. The crank 1 continues to rotate, the distance between the connection member 142A to the axis of the disk 2 gradually reduces. When the crank 1 is pivoted to 360-degree position, the distance between the connection member 142A to the axis of the disk 2 has the minimum value.

The action of the crank 1A relative to the disk 2 is the same as that of the crank 1, but the arm of force for the crank 1A is reversed to that of the crank 1. The trace that the cranks 1, 1A operates is an elliptical trace. The elliptical trace is similar to the movement of human's wrists or ankles so that when the users operate the facilities using the crank transmission mechanism of the present invention, the users has less change to be injured. In other words, when the crank 1/1A is located at horizontal position, because the arm of force is longer so that the user does not need to apply a large force, and when the crank 1/1A is located at the upright or downward position, because the required arm of force is short so that the user does not need to apply force to operate the cranks 1, 1A.

The collar members, the cranks, the shaft, the guide members and the rail portions are rotated relative to the disk during operation of the mechanism, and the distance between the connection members and the axis of the disk varies along with the operation so that the relative positions between the rail portions and the guide members continuously changed so as to form the elliptical trace of the cranks.

The crank transmission mechanism of the present invention is compact and the connection between the parts is reliable and precise. The mechanism can be easily stored and is strong and durable. The arm of force of the crank relative to the disk can be adjusted so as to save the user's effort. The mechanism is easily operated and can be used on bicycle, tricycle and elliptical exercising machine.

It is noted that the rail portions and the guide members can be exchanged, and the frame can also be made integrally with the bearings. The collar members can also be threaded or welded to the disk and the disk can be belt disk or chain disk.

While we have shown and described the embodiment in accordance with the present invention, it should be clear to those skilled in the art that further embodiments may be made without departing from the scope of the present invention.

What is claimed is:

1. A crank transmission mechanism comprising:
a crank unit having a rail portion (11) connected to the crank unit and a guide member (12), the rail portion (11) movably engaged with the guide member (12);
a disk (2), and
a transmission unit (3) connected between the crank unit and the disk (2), the rail portion (11) and the guide member connected to the transmission unit (3).

2. The mechanism as claimed in claim 1, wherein the crank unit includes two cranks (1, 1A).

3. The mechanism as claimed in claim 2, wherein the two cranks (1, 1A) each have the rail portion (11/11A) at one end thereof and the two respective rail portions (11, 11A) are movable engaged with two respective guide members (12, 12A).

4. The mechanism as claimed in claim 1, wherein the transmission unit (3) includes a shaft (13) and a collar unit (4), the shaft (13) connected to a central axis of the disk (2) and the collar unit (4) is mounted to the shaft (13), the collar unit (4) includes two collar members (14A, 14B), the collar member (4B) is connected to the disk (2) and the collar member (14A) is connected with the crank unit, a frame (4) is mounted to the shaft (13) and the two collar members (14A, 14B) are mounted to two ends of the frame (4), two first bearings (15, 15A) are located between the two collar members (14A, 14B) and the two ends of the frame (4), a common axis of the two collar members (14A, 14B) is parallel to central axis of the disk (2).

5. The mechanism as claimed in claim 4, wherein the frame (4) is a bottom bracket.

6. The mechanism as claimed in claim 4, wherein the two collar members (14A, 14B) each have an annular flange (141A/141B) extending inward from a side thereof, the side is located away from the frame (4), two respective connection members (142A, 142B) extend perpendicularly from the two flanges (141A, 141B), each of the two cranks (1, 1A) has a hole (111/111A) defined through and two respective bolts (18, 18A) extend through the two holes (111, 111A) and are connected with the connection members (142A, 142B).

7. The mechanism as claimed in claim 4, wherein the shaft (13) extends through a center of the disk (2).

8. The mechanism as claimed in claim 4, wherein the frame (4) includes a path (41) defined axially therethrough and the two second bearings (16, 16A) are mounted to two ends of the shaft (13) which extends through the path (41), two ends of the shaft (13) extend out from two ends of the frame (4).

9. The mechanism as claimed in claim 1, wherein the two guide members (12, 2A) each have a passage (122/122A) defined therein and the two ends of the shaft (13) are connected with the passages (122, 122A).

10. The mechanism as claimed in claim 9, wherein the two guide members (12) each include a protrusion (121/121A) extending therefrom and the passages (122, 122A) are defined in the two protrusions (121, 121A).

11. The mechanism as claimed in claim 9, wherein two threaded holes (131, 131A) are defined in the two ends of the shaft (13) and two through holes (123) are defined in the two guide members (12, 12A) respectively, two bolts (17, 17A) extend through the two through holes (123) and enter the passages (122, 122A) so as to be connected with the threaded holes (131, 131A) of the shaft (13).

12. The mechanism as claimed in claim 3, wherein the two cranks (1, 1A) are located parallel to the disk (2) and the rail portions (11, 11A) of the two cranks (1, 1A) are located close to a center of the disk (2), the two cranks (1, 1A) extend in two opposite directions.

13. The mechanism as claimed in claim 6, wherein the two connection members (142A, 142B) are located on a common plane which passes through two respective centers of the two collar members (14A. 14B), the two connection members (142A, 142B) are located on two opposite directions.
